(19) United States
(12) Patent Application Publication
(10) Pub. No.: US 2024/0300853 A1
(43) Pub. Date: Sep. 12, 2024

(54) PHASE SEPARATED GLASS SUBSTRATE WITH MAGNETIZABLE COMPONENT AND ANTIMICROBIAL COMPONENT, METHOD OF FORMING THE SUBSTRATE, METHODS OF USING THE SUBSTRATE, AND ARTICLES INCORPORATING THE SUBSTRATE

(71) Applicant: CORNING INCORPORATED, Corning, NY (US)

(72) Inventors: David Eugene Baker, Bath, NY (US); Bavani Balakrisnan, Corning, NY (US); Ling Cai, Painted Post, NY (US); Timothy Michael Gross, Painted Post, NY (US)

(21) Appl. No.: 18/271,326

(22) PCT Filed: Jan. 4, 2022
(86) PCT No.: PCT/US2022/011095

§ 371 Date: Jul. 7, 2023

Related U.S. Application Data
(60) Provisional application No. 63/136,381, filed on Jan. 12, 2021.

(51) Int. Cl. C03C 10/00

(52) U.S. Cl. CPC C03C 10/0081; C03C 10/0009; C03C 10/0054; C03C 2203/10; C03C 2203/52; C03C 2204/02; C03C 2214/08; C03C 2214/20

(57) ABSTRACT

A glass-ceramic substrate includes a continuous glass phase; a magnetizable component; and an antimicrobial component. The substrate can further include a discontinuous glass phase disposed in the continuous glass phase. The magnetizable component and the antimicrobial component can be disposed in the discontinuous glass phase. The substrate can include 45 percent to 60 percent SiO₂; 3 percent to 6 percent P₂O₅; 3 percent to 10 percent B₂O₃; 4 percent to 8 percent K₂O; 7 percent to 15 percent Fe₂O₃; and 15 percent to 25 percent CuO. A ratio of the mole percentage of CuO to Fe₂O₃ in the substrate can be 1.3 to 3.0. The magnetizable component can include one or more of delafossite and magnetite. The antimicrobial component can include one or more of cuprite and metallic copper. The substrate can exhibit a magnetic permeability of greater than or equal to 1.02μ_{R} at a frequency of 10,000,000 Hz.

### CROSS REFERENCE TO RELATED APPLICATION

This application claims the benefit of priority under 35 U.S.C. § 119 of U.S. Provisional Application No. 63/136,381, filed on Jan. 12, 2021, the content of which is relied upon and incorporated herein by reference in its entirety.

### BACKGROUND

The present invention generally relates to a phase-separated glass substrate that includes both a magnetizable component and an antimicrobial component, methods of making the substrate, and applications for such a substrate.

A person regularly encounters a surface that the person has to touch to achieve a goal. For example, the person regularly encounters an electronic device that the person has to touch to perform some action. The electronic device sometimes has a housing that the person has to hold, a touch screen display that the person has to touch to perform the action, or both. The surface can harbor a microbe that can be transferred to the person, or from the person to the surface (and then to another person). The microbe can decrease the health of the person. In addition to the electronic device, furniture and architectural articles, such as those used in medical and office settings, can provide such a surface. To reduce the ability of the surface to harbor the microbe, a material providing the surface can include a component that provides antimicrobial activity.

However, there is a problem in that the material providing the antimicrobial component includes the antimicrobial component dispersed relatively uniformly throughout the material and not primarily at the surface. Portions of the antimicrobial substance not at the surface of the material provide less antimicrobial activity than the antimicrobial component disposed at the surface, or no antimicrobial activity at all. Thus, incorporation of the antimicrobial component is less efficient and more costly than if the antimicrobial component was concentrated at the surface. In addition, after a usable life of the material has expired, there is a problem in that there is no known way to preferentially recover the antimicrobial substance for subsequent reuse.

### SUMMARY

The present disclosure addresses those problems with a phase separated glass substrate that includes both a magnetizable component and an antimicrobial component. The magnetizable component responds to a magnetic field. The antimicrobial component provides antimicrobial activity. When the glass substrate is ground into particles, each particle is itself the substrate that includes the magnetizable component and the antimicrobial component. The particles can then be added to material, such as plastic, and molded into a material. During molding, while the plastic is less viscous, a magnetic field can be applied, which draws the substrate particles toward the desired surface. The plastic cools and hardens forming an article with the particles of the substrate, each including the antimicrobial component, concentrated at or near the surface of the article. The article contains much less ineffective antimicrobial component dispersed within the plastic within the thickness of the article. This optimizes the use of the antimicrobial component. In addition, the article could be ground after the useful life of the article has ended, and the particles of the substrate could be reacquired for reuse via applying a magnetic field, because each particle of the substrate includes the magnetic component.

Further, particles of the substrate can be added to a liquid to sanitize the liquid. Again, each particle includes the antimicrobial component, and thus imparts antimicrobial action to sanitize the liquid. After the liquid is sanitized, a magnet can be placed in the liquid. Each particle is drawn to the magnet because each particle also includes the magnetic component in addition to the antimicrobial component. The magnet, with all of the particles of the substrate upon the magnet, can be withdrawn from the liquid, taking all of the particles of the substrate with it. The liquid is thus both sanitized and void of the plurality of substrates used to sanitize the liquid.

According to a first aspect of the present disclosure, a substrate comprises: a continuous glass phase; a magnetizable component; and an antimicrobial component.

According to a second aspect of the present disclosure, the first aspect is provided, the substrate further comprising: a discontinuous glass phase discontinuously disposed in the continuous glass phase; wherein, the magnetizable component and the antimicrobial component are disposed in the discontinuous glass phase.

According to a third aspect of the present disclosure, the second aspect is provided, wherein (i) the continuous glass phase includes a mole percentage of SiO₂ than is greater than a mole percentage of SiO₂ in the discontinuous glass phase; (ii) the discontinuous glass phase includes a mole percentage of P₂O₅ that is greater than a mole percentage of P₂O₅ in the continuous glass phase; (iii) one or more of delafossite and magnetite are disposed in the discontinuous glass phase; and (iv) one or more of cuprite and metallic copper are disposed in the discontinuous glass phase.

According to a fourth aspect of the present disclosure, any one of the first through third aspects is provided, the substrate further comprising: a composition comprising SiO₂, B₂O₃, P₂O₅, and K₂O.

According to a fifth aspect of the present disclosure, the fourth aspect is provided, wherein (i) the composition comprises (in mole percentage): 45 percent to 60 percent SiO₂; 3 percent to 6 percent P₂O₅; 3 percent to 10 percent B₂O₃; 4 percent to 8 percent K₂O; 7 percent to 15 percent Fe₂O₃; and 15 percent to 25 percent CuO, and (ii) a sum of the mole percentages is 100 percent, the mole percentages are determined on an oxide basis, and the mole percentages are determined via X-ray fluorescence spectrometry with all Cu-containing components considered to be CuO and all Fe-containing components considered to be Fe₂O₃.

According to a sixth aspect of the present disclosure, the fifth aspect is provided, wherein a ratio of the mole percentage of CuO in the composition to the mole percentage of Fe₂O₃ in the composition is 1.3 to 3.0.

According to a seventh aspect of the present disclosure, any one of the first through sixth aspects is provided, wherein the magnetizable component comprises one or more of delafossite and magnetite.

According to an eighth aspect of the present disclosure, any one of the first through seventh aspects is provided, wherein the antimicrobial component comprises cuprite.

According to a ninth aspect of the present disclosure, any one of the first through eighth aspects is provided, wherein the antimicrobial component comprises metallic copper.

According to a tenth aspect of the present disclosure, any one of the first through ninth aspects is provided, wherein the substrate exhibits a magnetic permeability of greater than or equal to 1.02 ρ_{R} at a frequency of 10,000,000 Hz.

According to an eleventh aspect of the present disclosure, any one of the first through tenth aspects is provided, wherein the substrate exhibits greater than 3 log₁₀ reduction of Staphylococcus Aureus.

According to a twelfth aspect of the present disclosure, a method of forming a substrate comprises: melting a plurality of oxides together to form a melt; and cooling the melt to form a substrate, wherein the substrate includes a continuous glass phase from the plurality of oxides, a magnetizable component from the plurality of oxides, and an antimicrobial component from the plurality of oxides.

According to a thirteenth aspect of the present disclosure, the twelfth aspect is provided, the method further comprising: subjecting the substrate to an environment having a temperature of at least 500° C. for at least 30 minutes.

According to a fourteenth aspect of the present disclosure, any one of the twelfth through thirteenth aspects is provided, the method further comprising: polishing the substrate in the presence of water.

According to a fifteenth aspect of the present disclosure, any one of the twelfth through fourteenth aspects is provided, the method further comprising: transforming the substrate into a plurality of particles of the substrate.

According to a sixteenth aspect of the present disclosure, any one of the twelfth through fifteenth aspects is provided, wherein the plurality of oxides melted together comprise SiO₂, P₂O₅, B₂O₃, K₂O.

According to a seventeenth aspect of the present disclosure, the sixteenth aspect is provided, wherein the plurality of oxides melted together further comprise iron oxide and another metallic oxide from which the antimicrobial component is formed.

According to an eighteenth aspect of the present disclosure, the seventeenth aspect is provided, wherein the iron oxide comprises Fe₂O₃, and the metallic oxide comprises CuO.

According to a nineteenth aspect of the present disclosure, the sixteenth aspect is provided, wherein the plurality of oxides melted together comprise (as batched, on an oxide basis, in mole percentage, with the total mole percentage of the plurality of oxides being 100 percent): 35 percent to 50 percent SiO₂; 3 percent to 8 percent P₂O₅; 5 percent to 12 percent B₂O₃; 5 percent to 11 percent K₂O; 7 percent to 17 percent Fe₂O₃; and 15 percent to 30 percent CuO.

According to a twentieth aspect of the present disclosure, the sixteenth aspect is provided, wherein (i) the plurality of oxides melted together further comprise Fe₂O₃ and CuO; and (ii) the plurality of oxides comprises a mole percentage of CuO that is greater than a mole percentage of Fe₂O₃.

According to a twenty-first aspect of the present disclosure, the twentieth aspect is provided, wherein a ratio of the mole percentage of CuO to the mole percentage of Fe₂O₃ of the plurality of oxides is 1.4 to 3.0.

According to a twenty-second aspect of the present disclosure, any one of the twelfth through twenty-first aspects is provided, wherein melting a plurality of oxides together to form a melt comprises subjecting the plurality of oxides or the melt to an environment having a temperature of 1500° C. to 1650° C.

According to a twenty-third aspect of the present disclosure, a method of sanitizing a liquid comprises: (a) placing a plurality of particles of a substrate in a liquid, each of the plurality of particles of the substrate comprising: a continuous glass phase, a magnetizable component, and an antimicrobial component; and (b) removing the plurality of particles of the substrate from the liquid.

According to a twenty-fourth aspect of the present disclosure, the twenty-third aspect is provided, wherein removing the plurality of substrates from the liquid comprises applying a magnetic field to the plurality of particles of the substrate.

According to a twenty-fourth aspect of the present disclosure, any one of the twenty-third through twenty-fourth aspects is provided, the method further comprising: placing the plurality of substrates in a second liquid.

According to a twenty-sixth aspect of the present disclosure, any one of the twenty-third through twenty-fifth aspects is provided, wherein (i) the substrate further comprises a discontinuous glass phase discontinuously disposed in the continuous glass phase; and (ii) the magnetizable component and the antimicrobial component are disposed in the discontinuous glass phase.

According to a twenty-seventh aspect of the present disclosure, any one of the twenty-third through twenty-sixth aspects is provided, wherein (i) the substrate comprises a composition comprising (in mole percentage): 45 percent to 60 percent SiO₂; 3 percent to 6 percent P₂O₅; 3 percent to 10 percent B₂O₃; 4 percent to 8 percent K₂O; 7 percent to 15 percent Fe₂O₃; and 15 percent to 25 percent CuO; (ii) a sum of mole percentages of the composition is 100 percent, the mole percentages are determined on an oxide basis, and the mole percentages are determined via X-ray fluorescence spectrometry with all Cu-containing components considered to be CuO and all Fe-containing components considered to be Fe₂O₃; (iii) the magnetizable component comprises one or more of delafossite and magnetite; and (iv) the antimicrobial component comprises one or more of cuprite and metallic copper.

According to a twenty-eighth aspect of the present disclosure, an article comprises: a surface; a plastic section forming part of the surface; and a plurality of particles of a substrate held in place by the plastic section, the plurality of particles of the substrate positioned so that a portion of the plurality of particles also form part of the surface of the article, and each of the plurality of particles of the substrate comprises: a continuous glass phase, a magnetizable component, and an antimicrobial component.

According to a twenty-ninth aspect of the present disclosure, the twenty-eighth aspect is provided, the article further comprising an interior disposed below the surface from the surface to a depth of at least 2 mm from the surface; wherein the plastic section holds more of the plurality of particles of the substrate in place at the surface and to 1 mm into the depth than from the surface than from 1 mm into the depth to 2 mm into the depth.

According to a thirtieth aspect of the present disclosure, any one of the twenty-eighth through twenty-ninth aspects is provided, the article further comprising: a second surface that faces in a generally opposite direction as the surface, and a thickness between the surface and the second surface, the thickness having a middle that is equidistant from the surface and the second surface; wherein, the plastic holds more of the plurality of substrates between the middle of the thickness and the surface than between the middle of the thickness and the second surface.

According to a thirty-first aspect of the present disclosure, any one of the twenty-eighth through thirtieth aspects is provided, wherein (i) the substrate further comprises a discontinuous glass phase discontinuously disposed in the continuous glass phase; and (ii) the magnetizable component and the antimicrobial component are disposed in the discontinuous glass phase.

According to a thirty-second aspect of the present disclosure, any one of the twenty-eighth through thirty-first aspects is provided, wherein the substrate comprises a composition comprising (in mole percentage): 45 percent to 60 percent SiO₂; 3 percent to 6 percent P₂O₅; 3 percent to 10 percent B₂O₃; 4 percent to 8 percent K₂O; 7 percent to 15 percent Fe₂O₃; and 15 percent to 25 percent CuO; a sum of the mole percentages of the composition is 100 percent, the mole percentages are determined on an oxide basis, the mole percentages are determined via X-ray fluorescence spectrometry with all Cu-containing components considered to be CuO and all Fe-containing components considered to be Fe₂O₃; and the magnetizable component comprises one or more of delafossite and magnetite; and the antimicrobial component comprises one or more of cuprite and metallic copper.

According to a thirty-third aspect of the present disclosure, a method of forming an article comprises: molding plastic and a plurality of substrates together to form an article while the plurality of substrates are subjected to a magnetic field, each of the plurality of substrates comprising: a continuous glass phase, a magnetizable component, and an antimicrobial component.

According to thirty-fourth aspect of the present disclosure, the thirty-third aspect is provided, wherein (i) the substrate further comprises a discontinuous glass phase discontinuously disposed in the continuous glass phase; and (ii) the magnetizable component and the antimicrobial component are disposed in the discontinuous glass phase.

According to a thirty-fifth aspect of the present disclosure, any one of the thirty-third through thirty-fourth aspects is provided, wherein (i) the substrate comprises a composition comprising (in mole percentage): 45 percent to 60 percent SiO₂; 3 percent to 6 percent P₂O₅; 3 percent to 10 percent B₂O₃; 4 percent to 8 percent K₂O; 7 percent to 15 percent Fe₂O₃; and 15 percent to 25 percent CuO; (ii) a sum of the mole percentages of the composition is 100 percent, the mole percentages are determined on an oxide basis, and the mole percentages are determined via X-ray fluorescence spectrometry with all Cu-containing components considered to be CuO and all Fe-containing components considered to be Fe₂O₃; (iii) the magnetizable component comprises one or more of delafossite and magnetite; and (iv) the antimicrobial component comprises one or more of cuprite and metallic copper.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is an elevation view of a substrate, illustrating the substrate having a continuous glass phase, a discontinuous glass phase dispersed throughout the continuous glass phase, a magnetizable component disposed within the discontinuous glass phase, and an antimicrobial component also disposed within the discontinuous glass phase;

FIG. 2 is a schematic of a method of forming the substrate of FIG. 1, illustrating steps of melting a plurality of oxides and then cooling the plurality of oxides;

FIGS. 3 and 4 are schematics of a method of sanitizing a liquid with a plurality of particles of the substrate of FIG. 1, illustrating steps of placing the plurality of particles of the substrate into a liquid, and removing the plurality of particles of the substrate, such as via a magnetic field that magnetizes the plurality of particles;

FIG. 5 is a perspective view of an article that includes a plastic section and a plurality of particles of the substrate of FIG. 1 held in place by the plastic section;

FIG. 6 is an elevation view of a cross-section of the article of FIG. 5 taken along line VI-VI of FIG. 5, illustrating the plurality of particles of the substrate disposed near and forming part of a surface of the article, with the antimicrobial component of some of the plurality of substrates forming part of the surface of the article;

FIG. 7 is a schematic of a method of forming the article of FIG. 6, illustrating a step of applying a magnetic field to the plurality of particles of the substrate while the plastic and the plurality of particles of the substrate are being molded to form the article, the magnetic field drawing the plurality of particles of the substrate toward a surface of the mold to form a portion of the surface of the article;

FIG. 8 is a graph of the results of an X-ray diffraction analysis for Example 1 of the substrate of FIG. 1, illustrating the presence of cuprite, which functions as the antimicrobial component, and both magnetite and delafossite, which function as the magnetic component;

FIG. 9 is a scanning electron microscope (“SEM”) image and energy dispersive spectroscopy (“EDS”) analysis of Example 1;

FIG. 10 is a SEM image of a polished sample of Example 1, illustrating the continuous glass phase forming a sea surrounding islands of the discontinuous glass phase, which includes crystals of cuprite, magnetite, and delafossite, as mentioned;

FIG. 11 is a graph of the results of an X-ray diffraction analysis for Example 2 of the substrate of FIG. 1, illustrating the presence of cuprite, which functions as the antimicrobial component, and delafossite, which function as the magnetic component;

FIG. 12 is an SEM image and EDS analysis of Example 2;

FIG. 13 is a graph of the results of an X-ray diffraction analysis for Example 3 of the substrate of FIG. 1, illustrating the presence of metallic copper, which functions as the antimicrobial component, and delafossite, which functions as the magnetic component;

FIG. 14 is an SEM image and EDS analysis of Example 2;

FIG. 15 is a graph of magnetic moment as a function of magnetic fields for each of the Examples 1-3 of the substrate of FIG. 1, illustrating Example 1 (including magnetite) having the greatest overall response to the magnetic fields applied, followed by Example 2 (including delafossite) and then Example 3 (including delafossite);

FIG. 16 is the same graph as FIG. 15, but focused upon the middle of the x-axis; and

FIG. 17 is a graph of magnetic permeability for each of the Examples 1-3 of the substrate of FIG. 1, illustrating Example 1 (including magnetite) having the greatest magnetic permeability followed by Example 2 (including delafossite) and then Example 3 (including delafossite).

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

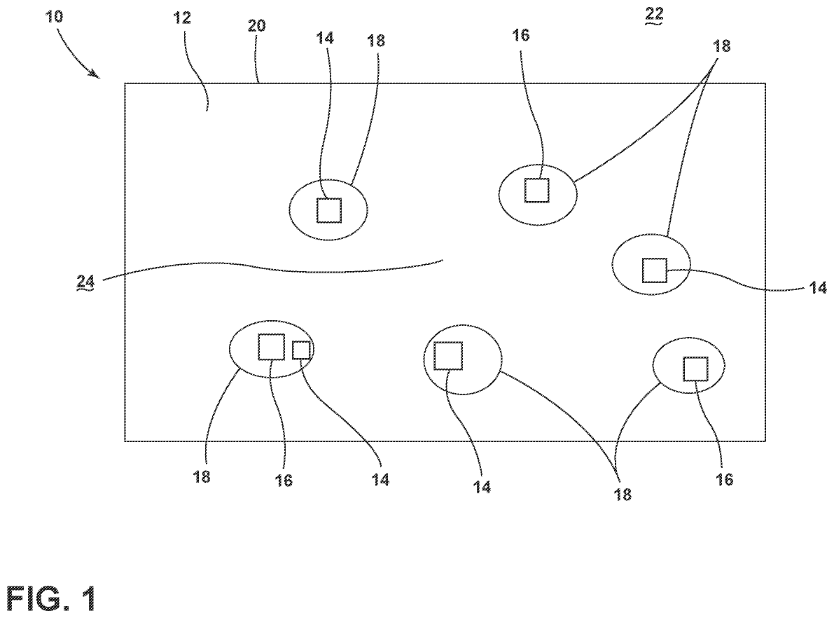

The Substrate. Referring to FIG. 1, a substrate 10 includes a continuous glass phase 12, a magnetizable component 14, and an antimicrobial component 16. In embodiments, the substrate 10 further includes a discontinuous glass phase 18 disposed in the continuous glass phase 12. The discontinuous glass phase 18 can form roughly spherically within the continuous glass phase 12. In some instances, the discontinuous glass phase 18 forms islands and the continuous glass phase 12 forms a sea surrounding the islands of the discontinuous glass phase 18. In embodiments, the magnetizable component 14 and the antimicrobial component 16 are disposed in the discontinuous glass phase 18, which is discontinuously disposed in the continuous glass phase 12. In embodiments, the magnetizable component 14 precipitates within the discontinuous glass phase 18 during formation of the substrate 10. In embodiments, a weight percentage of the continuous glass phase 12 in the substrate 10 is greater than a weight percentage of the discontinuous glass phase 18 in the substrate. The substrate 10 may be considered to be a glass substrate or a glass-ceramic substrate.

As used herein, “magnetizable” means that the component becomes magnetic when exposed to a magnetic field and is substantially non-magnetic when not exposed to the magnetic field. The disclosed magnetization is believed to be entirely or substantially, reversible over many magnetization cycles and over many years. In embodiments, the substrate 10 exhibits a magnetic permeability of greater than or equal to 1.0μ_{R} (e.g., 1.0μ_{R} to 2.0μ_{R}) at a frequency of 10,000,000 Hz (i.e., 10 MHz). The magnetic permeability can be measured with an impedance analyzer, such as the Agilent 4294A Precision Impedance Analyzer distributed by Agilent Technologies. Magnetic permeability is a measure of how easily a magnetic field magnetizes a material (such as the substrate 10) within the magnetic field. The greater the magnetic permeability, the more the magnetic field magnetizes the material. As applied here, the higher the magnetic permeability of the substrate 10, the easier it is for the substrate 10 to stick to a permanent magnet. In embodiments, the substrate 10 exhibits a magnetic permeability of greater than or equal to 1.02μ_{R} at a frequency of 10,000,000 Hz, such as 1.02μ_{R} to 1.10μ_{R}.

As used herein, “antimicrobial” means that the component destroys a microbe or reduces the ability of a microbe to replicate. In embodiments, the substrate 10 exhibits greater than 1 log₁₀ reduction of Staphylococcus Aureus. In embodiments, the substrate 10 exhibits greater than 2 log₁₀ reduction of Staphylococcus Aureus. In embodiments, the substrate 10 exhibits greater than 3 log₁₀ reduction of Staphylococcus Aureus. In embodiments, the substrate 10 exhibits greater than 4 log₁₀ reduction of Staphylococcus Aureus. Log₁₀ reduction can be determined via the procedures outlined in the United States Environmental Protection Agency Office of Pesticide Programs Protocol for the Evaluation of Bactericidal Activity of Hard, Non-porous Copper Containing Surface Products, dated 29 Jan. 2016.

The substrate 10 has a surface 20 that is open or exposed to an environment 22. The substrate 10 further has a bulk 24, which is disposed below the surface 20, and is not open or exposed to the environment 22. The environment 22 can be an ambient.

The substrate 10 includes a composition. In embodiments, the composition includes SiO₂. In embodiments, the composition includes B₂O₃. In embodiments, the composition includes P₂O₅. In embodiments, the composition includes K₂O. In embodiments, the composition includes all of SiO₂, B₂O₃, and P₂O₅. In embodiments, the composition includes all of SiO₂, B₂O₃, P₂O₅, and K₂O.

In embodiments, the composition of the substrate 10 (on an oxide basis, in mole percentage, with the total mole percentage of the composition being 100 percent) includes:
45 percent to 60 percent SiO₂;
3 percent to 6 percent P₂O₅;
3 percent to 10 percent B₂O₃;
4 percent to 8 percent K₂O;
7 percent to 15 percent Fe₂O₃; and
15 percent to 25 percent CuO.

In embodiments, the composition further includes 1 percent to 3 percent Al₂O₃. In embodiments, the composition further includes any one or more of CaO, MgO, ZnO, and Na₂O. In embodiments, the composition does not include Al₂O₃.

The composition of the substrate 10 can be determined via X-ray fluorescence (“XRF”) spectrometry, with all Cu-containing components considered to be CuO, and all Fe-containing components considered to be Fe₂O₃. With XRF spectrometry, the volume of the sample examined is sufficiently large so that the sample assuredly includes all of the continuous glass phase 12, the discontinuous glass phase 18, the magnetizable component 14, and the antimicrobial component 16. Thus, the XRF spectrometry analysis reveals an average composition of the substrate 10 as a whole.

In embodiments, the composition of the substrate 10, as measured by XRF spectrometry, includes a mole percentage of SiO₂ of 45 percent, 46 percent, 47 percent, 48 percent, 49 percent, 50 percent, 51 percent, 52 percent, 53 percent, 54 percent, 55 percent, 56 percent, 57 percent, 58 percent, 59 percent, 60 percent, or any range between any two of those mole percentages (e.g., 47 percent to 58 percent).

In embodiments, the composition of the substrate 10, as measured by XRF spectrometry, includes a mole percentage of P₂O₅ of 3 percent, 3.5 percent, 4 percent, 4.5 percent, 5 percent, 5.5 percent, 6 percent, or any range between any two of those mole percentages (e.g., 4 percent to 5.5 percent).

In embodiments, the composition of the substrate 10, as measured by XRF spectrometry, includes a mole percentage of B₂O₃ of 3 percent, 4 percent, 5 percent, 6 percent, 7 percent, 8 percent, 9 percent, 10 percent, or any range between any two of those mole percentages (e.g., 4 percent to 9 percent).

In embodiments, the composition of the substrate 10, as measured by XRF spectrometry, includes a mole percentage of K₂O of 4 percent, 4.5 percent, 5 percent, 5.5 percent, 6 percent, 6.5 percent, 7 percent, 7.5 percent, 8 percent, or any range between any two of those mole percentages (e.g., 4.5 percent to 7 percent).

In embodiments, the magnetizable component 14 of the substrate 10 comprises iron-containing constituents, such as a plurality of iron ions in mixed oxidation states. In embodiments, the composition of the substrate 10, as measured by XRF spectrometry, includes a mole percentage of Fe₂O₃ (where all identified Fe-containing constituents are assumed to be Fe₂O₃) of 7 percent, 8 percent, 9 percent, 10 percent, 11 percent, 12 percent, 13 percent, 14 percent, 15 percent, or any range between any two of those mole percentages (e.g., 9 percent to 14 percent). For the substrate 10 to exhibit a magnetic permeability of greater than or equal to 1.0μ_{R} (e.g., 1.0μ_{R} to 2.0μ_{R}) at a frequency of 10,000,000 Hz, the mole percentage of Fe₂O₃ in the substrate 10 should be at least 7 percent.

In embodiments, the plurality of iron ions can include Fe²⁺ and Fe³⁺. In embodiments, the plurality of iron ions in mixed oxidation states, and thus the magnetizable component 14 of the substrate 10, can comprise, for example, magnetite, delafossite, or both magnetite and delafossite. Magnetite has a crystal structure and a chemical composition of Fe²⁺Fe₂³⁺O₄²⁻. Delafossite has a crystal structure and a chemical composition of Cu¹⁺Fe³⁺O₂. Delafossite responds less to a magnetic field than magnetite but does respond. Scanning electron microscope (“SEM”) energy dispersive spectroscopy (“EDS”) and X-ray diffraction can be utilized to identify the presence of magnetite and delafossite.

In embodiments, the crystals of magnetite and delafossite have a largest dimension of 100 nm to 1000 nm, such as 100 nm to 500 nm, or 100 nm to 300 nm. The largest dimension can be determined via scanning electron microscope imagery.

In embodiments, the antimicrobial component 16 of the substrate 10 comprises copper-containing constituents, such as a plurality of copper ions (Cu¹⁺ ions, Cu²⁺ ions, or both Cu¹⁺ ions and Cu²⁺ ions), metallic copper, or a combination thereof. In embodiments, the composition of the substrate 10, as measured by XRF spectrometry, includes a mole percentage of CuO (where all identified Cu-containing constituents are assumed to be CuO) of 15 percent, 16 percent, 17 percent, 18 percent, 19 percent, 20 percent, 21 percent, 22 percent, 23 percent, 24 percent, 25 percent, or any range between any two of those mole percentages).

In embodiments, at least 75% of the plurality of copper ions is Cu¹⁺. The Cu¹⁺ ions may be present at the surface and/or the bulk 24 of the substrate 10. In embodiments, the Cu¹⁺ ions are atomically bonded to the atoms in the glass network that the continuous glass phase 12 forms, the glass network that the discontinuous glass phase 18 forms, or both. In embodiments, the Cu¹⁺ ions are present in the form of Cu¹⁺ crystals that are held within the glass network that the continuous glass phase 12 forms, the glass network that the discontinuous glass phase 18 forms, or both. In embodiments, both Cu¹⁺ crystals and Cu¹⁺ ions not associated with a crystal (e.g., those that are atomically bonded to the atoms in the glass network) are present in the substrate 10.

In embodiments, at least a portion of the Cu¹⁺ ions are in the form of cuprite (Cu₂O). Cuprite has a crystal structure. The cuprite of the substrate 10 can be dispersed in the discontinuous glass phase 18, or both the continuous glass phase 12 and the discontinuous glass phase 18. In embodiments, the crystals of cuprite have a largest dimension of 100 nm to 1000 nm. In embodiments, at least a portion of the Cu¹⁺ ions are in the form of delafossite, mentioned above (Cu¹⁺Fe³⁺O₂). Delafossite exhibits no antimicrobial activity however, except at high concentrations. SEM/EDS can be utilized to identify the presence of cuprite.

In embodiments, the amount of Cu²⁺ is minimized or is reduced such that the substrate 10 is substantially free of Cu²⁺ (e.g., tenorite, CuO). In other embodiments, less than about 25% of the plurality of copper ions is Cu²⁺. SEM/EDS can be utilized to identify the presence of tenorite.

In embodiments, a ratio of the mole percentage of CuO to the mole percentage of Fe₂O₃ in the substrate 10 is 1.4 to 3.0, such as 1.4, 1.5, 1.6, 1.7, 1.8, 1.9, 2.0, 2.1, 2.2, 2.3, 2.4, 2.5, 2.6, 2.7, 2.8, 2.9, 3.0, or any range including any two of those mole percentages (e.g., 1.8 to 2.2, 1.9 to 2.1, 2.4 to 2.6, 1.5 to 1.7, or 1.9 to 3.0, and so on).

The continuous glass phase 12 is compositionally different than the discontinuous glass phase 18. For example, in embodiments, the continuous glass phase 12 includes a mole percentage of SiO₂ that is different (e.g., greater) than a mole percentage of SiO₂ in the discontinuous glass phase 18. In embodiments, the discontinuous glass phase 18 includes a mole percentage of a glass-forming oxide other than SiO₂ that is different than the mole percentage of the glass-forming oxide in the continuous glass phase 12. For example, in embodiments, the discontinuous glass phase 18 includes a mole percentage of the glass-forming oxide P₂O₅ that is different (e.g., greater than) than the mole percentage of P₂O₅ in the continuous glass phase 12. The continuous glass phase 12 may be considered to be “silicon rich” compared to the discontinuous glass phase 18. The discontinuous glass phase 12 may be considered to be “phosphorous rich” compared to the continuous glass phase 12. SEM/EDS can be utilized to determine relative compositional differences between the composition of the continuous glass phase 12 versus the discontinuous glass phase 18.

The continuous glass phase 12 may be referred to as a “durable phase,” while the discontinuous glass phase 18 may be referred to as a “degradable phase.” The discontinuous glass phase 18 is degradable in the sense that the discontinuous glass phase 18 dissolves in the presence of liquid water, and does so faster than the continuous glass phase 12, which has a greater mole percentage of silicon. Dissolution of the discontinuous glass phase 18 reveals the antimicrobial component 16, such as crystals of cuprite or metallic copper that are thus available at the surface 20 to impart antimicrobial activity. Antimicrobial activity can occur through leaching of Cu¹⁺ ions and/or Cu²⁺ ions from the substrate 10 to the microbe via a leachate such as liquid water.

In embodiments, a weight percentage of the continuous glass phase 12 of the substrate 10 is greater than a weight percentage of the discontinuous glass phase 18 of the substrate 10. In embodiments, both the magnetizable component 14 (such as crystals of magnetite, delafossite, or both) and the antimicrobial component 16 (such as crystals of cuprite, metallic copper, or both) occur predominately within the discontinuous glass phase 18. The substrate 10 has a generally black color.

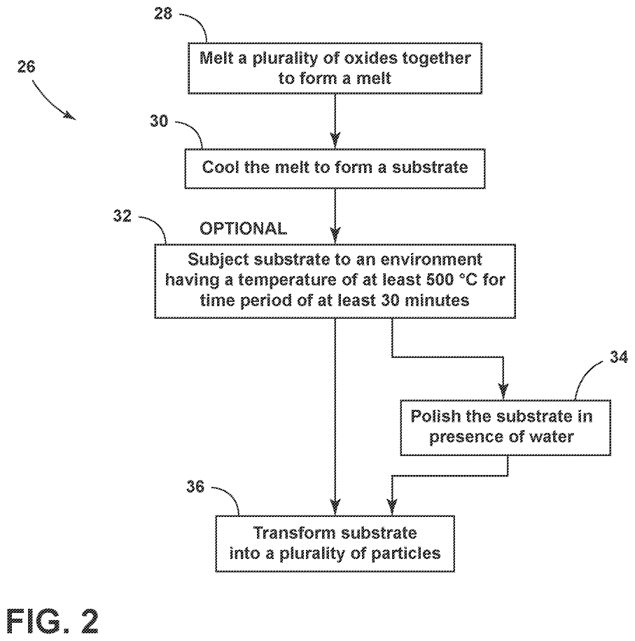

Formation of the Substrate. In embodiments, the substrate 10 is formed from individual oxides, which are then mixed together and heat treated to form the substrate 10. For example, referring now to FIG. 2, a method 26 of forming the substrate 10 includes: (i) a step 28 of melting a plurality of oxides together to form a melt and (ii) a step 30 of cooling the melt to form the substrate 10, wherein the substrate 10 includes the continuous glass phase 12 from the plurality of oxides, the magnetizable component 14 from the plurality of oxides, the antimicrobial component 16 from the plurality of oxides, and, optionally, the discontinuous glass phase 18 from the plurality of oxides.

In embodiments, the plurality of oxides melted together include SiO₂, P₂O₅, B₂O₃, and K₂O. In embodiments, the plurality of oxides melted together includes: SiO₂, P₂O₅, B₂O₃, K₂O, an iron oxide, and another metallic oxide from which the antimicrobial component 16 is formed. In embodiments, the iron oxide is Fe₂O₃. In embodiments, the metallic oxide from which the antimicrobial component 16 is formed is a copper oxide, such as CuO.

In embodiments, the plurality of oxides melted together include (as batched, on an oxide basis, in mole percentage, with the total mole percentage of the plurality of oxides being 100 percent):
35 percent to 50 percent SiO₂;
3 percent to 8 percent P₂O₅;
5 percent to 12 percent B₂O₃;
5 percent to 11 percent K₂O;
7 percent to 17 percent Fe₂O₃;
15 percent to 30 percent CuO.

In embodiments, the plurality of oxides further includes 1 percent to 3 percent Al₂O₃. In embodiments, the plurality of oxides further includes any one or more of CaO, MgO, ZnO, and Na₂O. In embodiments, the plurality of oxides does not include Al₂O₃.

SiO₂ serves as the primary glass-forming oxide of both the continuous glass phase 12 and the discontinuous glass phase 18. The amount of SiO₂ present in the plurality of oxides should be sufficient to provide the substrate 10 with the requisite chemical durability suitable for its use or application. The upper limit of SiO₂ may be selected to control the melting temperature of the compositions described herein. For example, excess SiO₂ could drive the melting temperature at 200 poise to high temperatures at which defects such as fining bubbles may appear or be generated during processing and in the substrate 10. Furthermore, compared to most oxides, SiO₂ decreases the compressive stress created by a subsequent ion exchange process of the substrate 10. In other words, the substrate 10 with excess SiO₂ may not be ion-exchangeable to the same degree as the substrate 10 formed without excess SiO₂. Additionally or alternatively, SiO₂ present in the plurality of oxides according to one or more embodiments could increase the plastic deformation prior break properties of the substrate 10. An increased SiO₂ content may also increase the indentation fracture threshold of the substrate 10.

In embodiments, the plurality of oxides includes a mole percentage SiO₂ of 35 percent, 36 percent, 37 percent, 38 percent, 39 percent, 40 percent, 41 percent, 42 percent, 43 percent, 44 percent, 45 percent, 46 percent, 47 percent, 48 percent, 49 percent, 50 percent, or any range between any two of those mole percentages (e.g., 38 percent to 49 percent).

In embodiments, the plurality of oxides includes P₂O₅, which serves as a secondary glass-forming oxide that forms at least part of the discontinuous glass phase 18 of the substrate 10. Three percent P₂O₅ is thought to be a minimum mole percentage in the plurality of oxides as batched to result in sufficient generation of the discontinuous glass phase 18 for the antimicrobial component 16 to be present at the surface of the substrate 10. When the mole percentage of P₂O₅ in the plurality of oxides does not exceed 8 percent, then formation of the discontinuous glass phase 18 is suitably uniform throughout the substrate 10.

In embodiments, the plurality of oxides includes a mole percentage of P₂O₅ of 3 percent, 4 percent, 5 percent, 6 percent, 7 percent, 8 percent, or any range between any two of those mole percentages (e.g., 5 percent to 7 percent).

In embodiments, the plurality of oxides includes B₂O₃, which serves as another secondary glass-forming oxide that forms at least part of the discontinuous glass phase 18 of the substrate 10. In other words, B₂O₃, along with P₂O₅, provide the phase separation tendencies so that both the continuous glass phase 12 and the discontinuous glass phase 18 develop during formation of the substrate 10. In addition, it is believed that the inclusion of B₂O₃ in the plurality of oxides imparts damage resistance to the substrate 10, despite the tendency for B₂O₃ to impart increased susceptibility to the discontinuous glass phase 18 to dissolve in the presence of liquid water. Further, the presence of B₂O₃ lowers the melting temperature of the plurality of oxides (i.e., the temperature required to form the melt from the plurality of oxides). It is believed that at least 5 mole percentage B₂O₃ allows for sufficient discontinuous glass phase 18 to form in the substrate 10 upon cooling of the melt, and more than 12 percentage B₂O₃ is unnecessary to achieve a sufficient low melting point of the plurality of oxides to form the substrate 10.

In embodiments, the plurality of oxides includes a mole percentage of B₂O₃ of 5 percent, 6 percent, 7 percent, 8 percent, 9 percent, 10 percent, 11 percent, 12 percent, or any range between any two of those mole percentages (e.g., 8 percent to 11 percent).

In embodiments, the plurality of oxides includes K₂O. Potassium ions preferentially form in the discontinuous glass phase 18 upon cooling of the melt. The glass network that the phosphorous, boron, and silicon form in the discontinuous glass phase 18 forms around potassium ions. A potassium ion is roughly the size of a molecule of water. Thus, in the presence of liquid water, potassium ions migrate from the discontinuous glass phase 18 to the liquid water, and molecules of liquid water migrate from the liquid water into the glass network of the discontinuous glass phase 18, which causes the discontinuous glass phase 18 to dissolve at a higher rate than the continuous glass phase 12. The presence of K₂O additionally lowers the melting temperature of the composition. Five mole percentage K₂O is thought to be the minimum mole percentage sufficient to render the discontinuous glass phase 18 sufficiently dissolvable in liquid water to expose the antimicrobial component 16 at the surface 20. More than 12 mole percentage of K₂O could render the discontinuous glass phase 18 too degradable in liquid water, which may cause failure of the substrate 10 and separation of the antimicrobial component 16 from the magnetizable component 14.

In embodiments, the plurality of oxides includes a mole percentage of K₂O of 5 percent, 6 percent, 7 percent, 8 percent, 9 percent, 10 percent, 11 percent, or any range between any two of those mole percentages (e.g., 8 percent to 11 percent).

In embodiments, the plurality of oxides includes Fe₂O₃. Fe₂O₃ forms, either alone, or with CuO, the magnetizable component 14, which as mentioned can be magnetite, delafossite, or both. In embodiments, the plurality of oxides includes CuO. CuO forms the antimicrobial component 16, which as mentioned can be Cu¹⁺ ions, cuprite, or metallic copper. It is believed that at least 7 mole percentage of Fe₂O₃ in the plurality of oxides is required for beneficial amounts of the magnetizable component 14 to generate during formation of the substrate 10. In addition, it is believed that at least 13 mole percentage of CuO in the plurality of oxides is required for beneficial amounts of the antimicrobial component 16 to generate during formation of the substrate 10. In embodiments, the plurality of oxides includes a mole percentage of Fe₂O₃ of 7 percent, 8 percent, 9 percent, 10 percent, 11 percent, 12 percent, 13 percent, 14 percent, 15 percent, 16 percent, 17 percent, or any range between any two of those mole percentages (e.g., 9 percent to 16 percent). In embodiments, the plurality of oxides includes a mole percentage of CuO of 15 percent, 16 percent, 17 percent, 18 percent, 19 percent, 20 percent, 21 percent, 22 percent, 23 percent, 24 percent, 25 percent, 26 percent, 27 percent, 28 percent, 29 percent, 30 percent, or any range between any two of those mole percentages (e.g., 17 percent to 28 percent).

The ratio of the mole percentage of CuO to the mole percentage of Fe₂O₃ is consequential to crystal formation from the Fe₂O₃ and the CuO from the plurality of oxides. Cuprite is generally more desirable in the substrate 10 than metallic copper, delafossite, and atomically bonded Cu¹⁺ ions in the glass structure, because cuprite appears to offer relatively higher antimicrobial activity. Similarly, magnetite is generally more desirable in the substrate 10 than delafossite, because magnetite appears to offer a relatively higher degree of magnetic permeability than delafossite.

In embodiments, the mole percentage of CuO in the plurality of oxides is greater than the mole percentage of Fe₂O₃ in the plurality of oxides. Experiments reveal that when the mole percentage of CuO in the plurality of oxides is less than the mole percentage of Fe₂O₃ in the plurality of oxides, neither metallic copper nor cuprite form in the substrate 10 while cooling the melt. Rather, the copper is transformed to delafossite, which alone may be insufficient to imbue the substrate 10 with appreciable antimicrobial activity.

In embodiments, a ratio of the mole percentage of CuO to the mole percentage of Fe₂O₃ in the plurality of oxides is 1.4 to 3.0, such as 1.4, 1.5, 1.6, 1.7, 1.8, 1.9, 2.0, 2.1, 2.2, 2.3, 2.4, 2.5, 2.6, 2.7, 2.8, 2.9, 3.0, or any range between any two of those values, such as 1.4 to 2.4, or 1.9 to 3.0. Beginning at the ratio of 1.4, there is sufficient CuO compared to Fe₂O₃, for metallic copper to form in addition to delafossite. When the ratio is 1.9 to 3.0, there is sufficient CuO compared to Fe₂O₃, for cuprite to form. When the ratio is between 1.9 and 3.0, and the mole percentage of Fe₂O₃ in the plurality of oxides is at least 9.5 mole percentage (e.g., 9.5 percent to 17 percent), there is both (i) sufficient CuO compared to Fe₂O₃, for cuprite to form and (ii) sufficient Fe₂O₃ for magnetite to form during cooling of the melt and formation of the substrate 10.

Note that the various mole percentages of the plurality of oxides described to form the substrate 10 is different than the mole percentages of the composition of the substrate 10 as formed. During the step 28 of melting the oxides, there is unproportioned volatilization of the oxides of the plurality of oxides. For example, copper may volatize out more than silicon. In embodiments, the step 28 of melting the plurality of oxides to form the melt occurs at a temperature of 1500° C. to 1650° C., which is well above the melting temperature of the plurality of oxides. In other words, the plurality of oxides or the melt is subjected to an environment having a temperature of 1500° C. to 1650° C. The environment can be a furnace. At such an elevated temperature, some volatilization occurs. In addition, at such an elevated temperature, the plurality of oxides is starved of oxygen and, thus, crystals of cuprite are more likely to form in the substrate 10 than crystals of the further oxidized tenorite. For recall, cuprite with the Cu¹⁺ ions provide greater antimicrobial activity than tenorite with the Cu²⁺ ions. The aforementioned formation of the continuous glass phase 12 distinct from the discontinuous glass phase 18 further occurs upon cooling to ambient temperature from such elevated temperatures. The separation of those phases maintains while the substrate 10 cools to ambient temperature during the step 30, and no further heat treatment is required.

However, in embodiments, at a step 32, the method 26 further includes subjecting the substrate 10 to an environment having a temperature of at least 500° C. for a time period of at least 30 minutes. The environment again can be a furnace. For example, the temperature of the environment can be 500° C. to 800° C., and the time period can be 30 minutes to 24 hours. This subsequent heat treatment of the step 32 can cause crystals of cuprite, magnetite, and delafossite to agglomerate into larger crystals. In addition, the subsequent heat treatment of step 32 can cause larger regions of the discontinuous glass phase 18 to consume smaller regions of the discontinuous glass phase 18, resulting in the remaining regions of the discontinuous glass phase 18 to be larger. In embodiments, single discrete formations of the discontinuous glass phase 18 surround both a formation of the antimicrobial component 16 (e.g., a crystal of cuprite) and a formation of the magnetizable component 14 (e.g., a crystal of magnetite). Generally, however, a single discrete formation of the discontinuous glass phase 18 includes either a formation of the antimicrobial component 16 or a formation of the magnetizable component 14, but not both.

In embodiments, at a step 34, the method 26 further incudes polishing the substrate 10 in the presence of water. As mentioned, the substrate 10 includes both the continuous glass phase 12 and the discontinuous glass phase 18. The continuous glass phase 12 is richer in silicon oxide bonds than the discontinuous glass phase 18. In addition, the discontinuous glass phase 18 is richer in phosphorous oxide and boron oxide bonds than the continuous glass phase 12, and includes a higher proportion of the potassium ions. In the presence of water, the discontinuous glass phase 18 dissolves faster than the continuous glass phase 12. The partially dissolved discontinuous glass phase 18 reveals the antimicrobial component 16 as part of the surface 20 of the substrate 10, allowing the antimicrobial component 16 to more effectively provide antimicrobial activity. For example, copper ions can migrate from the antimicrobial component 16 to the microbe. The polishing in the presence of water thus increases the antimicrobial activity of the substrate 10.

In embodiments, at a step 36, the method 26 further includes transforming the substrate 10 into a plurality of particles 38 (e.g., a powder). For example, the substrate 10 in sheet form can be ground into the particles. In embodiments, the particles of the substrate 10 can have a D50 (e.g., mean diameter) particle size of 2 μm to 10 μm, such as 2.0, 2.5, 2.6, 2.7, 2.8, 2.9, 3.0, 3.1, 3.2, 3.3, 3.4, 3.5, 3.6, 3.7, 3.8, 3.9, 4.0, 5.0, 6.0, 7.0, 8.0, 9.0, 10.0, or any range between any two of those values (e.g., 2.8 μm to 3.6 μm). At such a mean diameter each of the particles 38 of the substrate 10 are to include both the antimicrobial component 16 and the magnetizable component 14 (e.g., a crystal of cuprite and a crystal of magnetite). As the plurality of particles is formed from the substrate 10, the particles also can be referred to as the substrate, and the description of the substrate herein can be applicable to the particles.

Applications of the Substrate. In embodiments, the substrate 10 has a form of a sheet as illustrated in FIG. 1. The substrate 10, in sheet form, has antimicrobial properties and is also magnetic, which has a use in many applications. For example, the substrate 10, as a sheet, can be portable and fixed in place with application of a magnetic force to the substrate 10. Wiping the sheet of the substrate 10 with a damp cloth can allow copper ions from the substrate to migrate to microbes, sanitizing the substrate 10.

In embodiments, the substrate 10, when ground into the plurality of particles 38 of the substrate 10, can be added to a liquid 40. The substrate 10 adds antimicrobial activity to the liquid 40. In embodiments, the liquid 40 is a paint. The paint can then be applied to walls and other things to reduce the ability of the walls and other things to be a vector in the spreading of microbes. The antimicrobial component 16 in each of the plurality of particles 38 of the substrate 10, which is dispersed throughout the paint now on the walls or other things, kills or reduces the ability of the microbe to replicate.

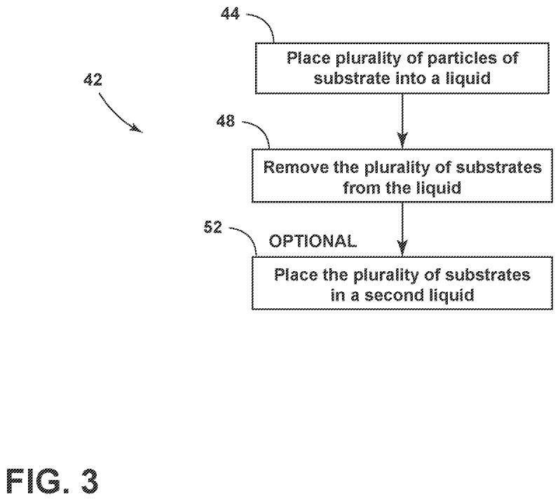

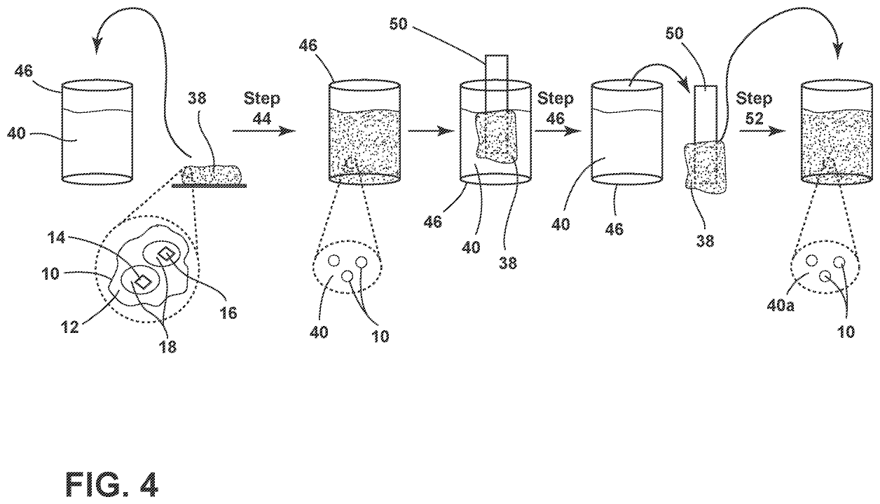

Referring now to FIGS. 3 and 4, a method 42 of sanitizing the liquid 40 is herein disclosed. At a step 44, the method 42 includes placing the plurality of particles 38 of the substrate 10 in the liquid 40. In embodiments, the liquid 40 is disposed in a container 46. The liquid 40 can be any liquid 40, and not the paint described above. The liquid 40 can be tainted by undesired microbes. In embodiments, the plurality of the particles 38 of the substrate 10 is a powder form of the substrate 10, which as discussed can be formed by making the substrate 10 and then grinding the substrate 10. Each of the plurality of particles 38 of the substrate 10 includes the continuous glass phase 12, the magnetizable component 14, the antimicrobial component 16, and the discontinuous glass phase 18 (if included). The antimicrobial component 16 of the plurality of particles 38 of the substrate 10 destroy at least a portion of the microbes in the liquid 40, thus sanitizing the liquid 40.

At a step 48, the method 42 further includes removing the plurality of the particles 38 of the substrate 10 from the liquid 40. In embodiments, the step 48 includes magnetizing the plurality of the particles 38 of the substrate 10. For example, a magnet 50 can be placed in the liquid 40. The magnet 50 produces a magnetic field that magnetizes the magnetizable component 14 of each of the plurality of the particles 38 of the substrate 10. The magnetic field thus draws each of the plurality of the particles 38 of the substrate 10 in the liquid 40 to the magnet 50. In embodiments, the magnet 50 has a remanent magnetization of 1.0 T to 1.5 T. In embodiments, the magnet 50 is a neodymium or other rare earth magnet. The magnet 50 is then removed from the liquid 40, removing the plurality of particles 38 of the substrate 10 with the magnet 50, as well. The liquid 40 is thus then void of plurality of the particles 38 of the substrate 10, and the liquid 40 in a more sanitized state then before the step 44 when the plurality of particles 38 of the substrate 10 was added to the liquid 40.

In embodiments, at a step 52, the method 42 further includes placing the plurality of particles 38 of the substrate 10 into a second liquid 40a. The plurality of particles 38 of the substrate 10 then sanitizes the second liquid 40a, because each of plurality of particles 38 of the substrate 10 includes the antimicrobial component 16. The plurality of particles 38 of the substrate 10 is thus collectible via the magnet 50 and reusable to sanitize repeatedly different liquids 40, 40a . . . 40n. This reduces the per-use cost of the plurality of particles 38 of the substrate 10 and optimizes use of the plurality of oxides used to form the substrate 10.

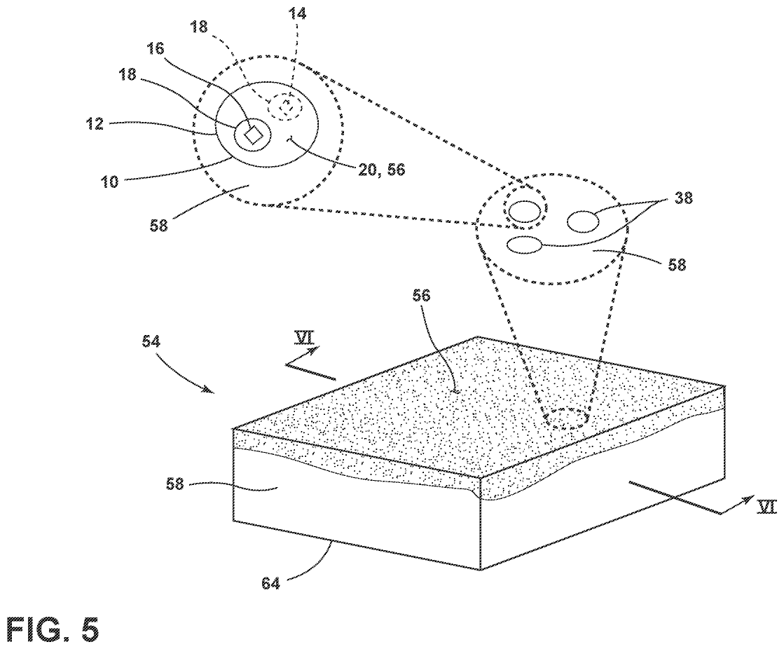

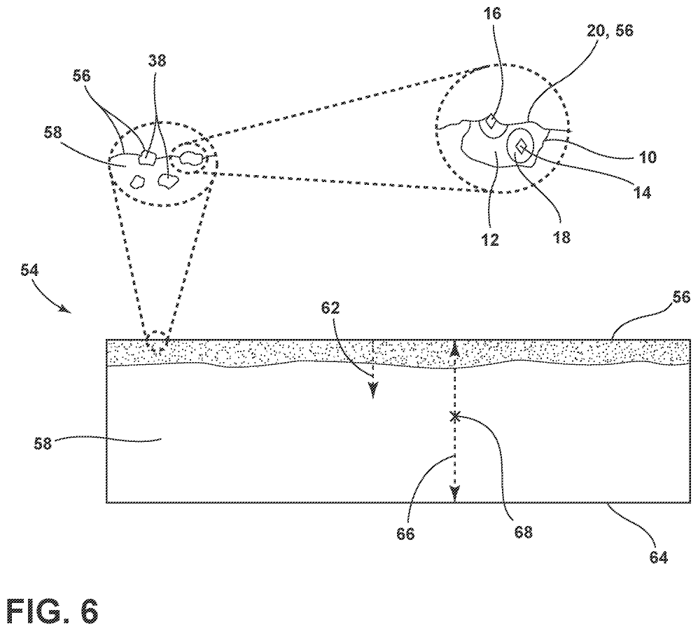

Referring now to FIGS. 5 and 6, an article 54 includes a surface 56, a plastic (e.g., polymer) section 58, and the plurality of particles 38 of the substrate 10. The plastic section 58 holds the plurality of particles 38 of the substrate 10. The plastic section 58 forms part of the surface 56 of the article 54. A portion of the plurality of particles 38 of the substrate 10 is positioned to also form part of the surface 56 of the article 54. The remaining of the plurality of particles 38 of the substrate 10 are dispersed throughout the plastic section 58 below the surface 56. As discussed, each of the plurality of particles 38 of the substrate 10 include the continuous glass phase 12, the magnetizable component 14, the antimicrobial component 16, and, in embodiments, the discontinuous glass phase 18. In embodiments of the substrate 10 that include the discontinuous glass phase 18, the antimicrobial component 16 and the magnetizable component 14 can be deposed in the discontinuous glass phase 18. Because each of the plurality of particles 38 of the substrate 10 includes the antimicrobial component 16, the antimicrobial component 16 exposed to or forming part of the surface 56 of the article 54 provides the article 54 with antimicrobial properties.

In embodiments, the article 54 further includes an interior 60 disposed below the surface 56 to a depth 62 of at least 2 mm from the surface 56. In embodiments, the plastic section 58 holds more of the plurality of particles 38 of the substrate 10 in place at the surface 56 and to 1 mm into the depth 62 than from 1 mm into the depth 62 to 2 mm into the depth 62. The plurality of particles 38 of the substrate 10 are concentrated at the surface 56 and 1 mm into the depth 62 from the surface 56. There is less of the plurality of particles 38 of the substrate 10 farther into the depth 62 than from the surface 56 to 1 mm into the depth 62. Because the efficacy of the antimicrobial component 16 to provide antimicrobial action decreases substantially as a function of the depth 62 from the surface 56, the article 54 optimizes the use and quantity of the plurality of particles 38 of the substrate 10 utilized and, therefore, the antimicrobial component 16. The portion of the plurality of particles 38 of the substrate 10 farther into the depth 62 is not providing the article 54 with substantial antimicrobial activity and it is optimal to reduce or eliminate the concentration of the plurality of particles 38 of the substrate 10 farther into the depth 62.

In embodiments, the article 54 further includes a second surface 64. The second surface 64 faces in a generally opposite direction as the surface 56. In such embodiments, the surface 56 is more likely to encounter human touch than the second surface 64. The article 54 further includes a thickness 66 that separates the first surface 56 and the second surface 64. The depth 62 is into the thickness 66. The thickness 66 has a middle 68. The middle 68 is equidistant from the surface 56 and the second surface 64. The plastic section 58 holds more of the plurality of particles 38 of the substrate 10 between the surface 56 and the middle 68 of the thickness 66 than between the middle 68 of the thickness 66 and the second surface 64. As mentioned, the plurality of particles 38 of the substrate 10, which include the antimicrobial component 16, are concentrated at and toward the surface 56, which is more likely to be touched. The second surface 64 may not be exposed to an external environment when incorporated into an end-use product.

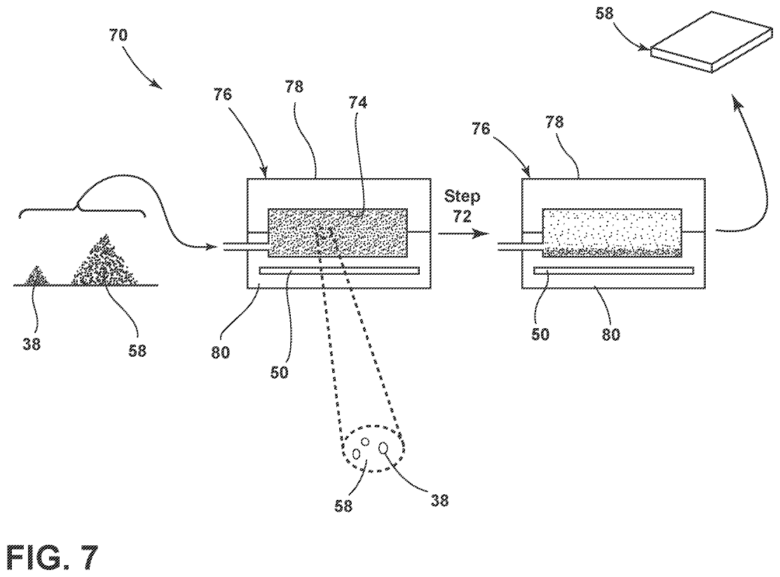

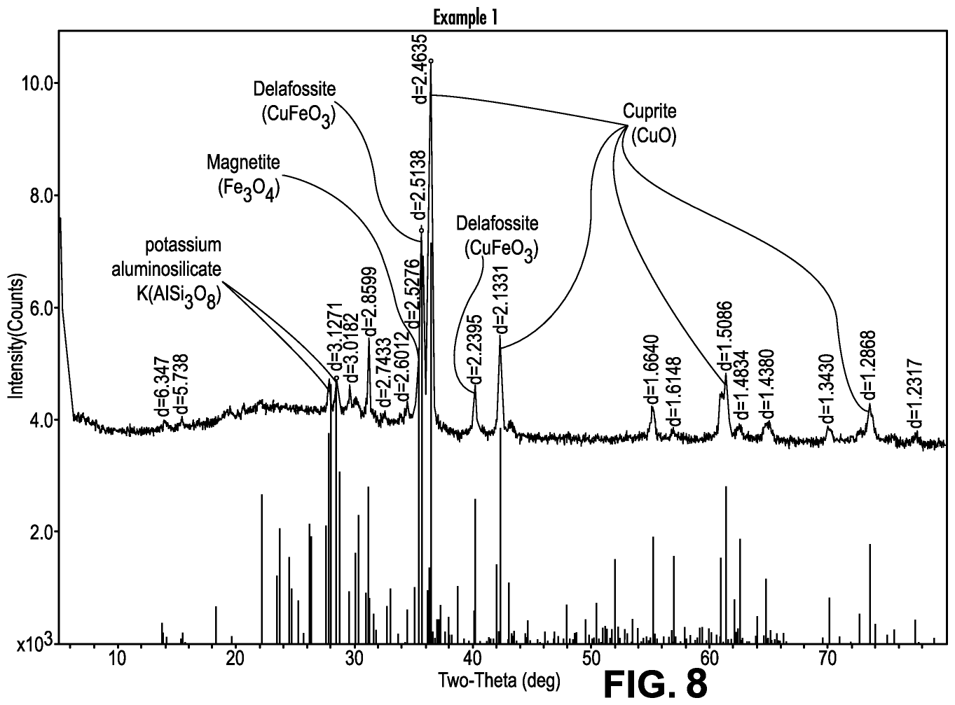

Referring now to FIGS. 7 and 8, a method 70 of forming the article 54 is herein disclosed. At a step 72, the method 70 includes molding plastic 58 and the plurality of particles 38 of the substrate 10 together while the plurality of particles 38 of the substrate 10 are subject to a magnetic field that magnetizes the plurality of particles 38 of the substrate 10. For example, the plastic 58 can be in the form of pellets. The plurality of particles 38 of the substrate 10 as discussed above can be a powder form of the substrate 10, so that each of the plurality of particles 38 of the substrate 10 includes the continuous glass phase 12, the magnetizable component 14, the antimicrobial component 16, and the discontinuous glass phase 18, if included. The plurality of particles 38 of the substrate 10 and the plastic 58 can be melted together and injected into a cavity 74 of a mold 76. The mold 76 can include a first piece 78 that mates with a second piece 80, to allow the first piece 78 to separate from the second piece 80 after molding to release the article 54 from the mold 76. In embodiments, the magnet 50 applies the magnetic field, which extends into the cavity 74. For example, the magnet 50 can be disposed at the second piece 80 of the mold 76, and beneath the cavity 74 and adjacent to a surface 82 of the mold 76 defining part of the cavity 74. The plurality of particles 38 of the substrate 10, which was injected into the cavity 74 with the plastic 58, is subjected to the magnetic field. The magnetic field attracts the plurality of particles 38 of the substrate 10, because each of the plurality of the particles 38 of the substrate 10 includes the magnetizable component 14. The magnetic field pulls the plurality of the particles 38 of the substrate 10 toward the magnet 50 and to the surface 82 of the mold 76 disposed between the magnet 50 and the plurality of particles 38 of the substrate 10. The plastic 58 cools in the mold 76 becoming solid and holds the plurality of particles 38 of the substrate 10 in position, thus forming the article 54. The article 54 is then removed from the mold 76. The article 54 is as described above, with the plurality of particles 38 of the substrate 10 concentrated at or near the surface 56 of the article 54.

The method 70 allows for a reduced quantity of the plurality of particles 38 of the substrate 10 to be molded with the plastic to form the article 54 to achieve a desired level of antimicrobial activity at the surface 56 of the article 54. Without the magnetic field, the plurality of particles 38 of the substrate 10 remains relatively in place within the mold 76 as injected with the plastic 58. Thus, after the plastic 58 cools and the article 54 is formed, the plurality of particles 38 of the substrate 10 are relatively evenly dispersed throughout the plastic 58. However, in response to the magnetic field, the plurality of particles 38 of the substrate 10 are magnetized and migrate through the relatively viscous plastic 58 toward the magnet 50, and collect at the surface or near the surface 82 of the mold 76, which thus renders the plurality of particles 38 of the substrate 10 forming more of the surface 56 of article 54 than if the magnetic field was not present. Accordingly, less of the plurality of particles 38 of the substrate 10 needs to be utilized with the method 70 than without the method 70 to achieve the same level of antimicrobial activity at the surface 56 of the article 54.

### EXAMPLES

Examples 1-3. For Examples 1-3, the following oxides were batched together in the following mole percentages (different mole percentages for each example), heated to form a melt, and then cooled to form a substrate. The mole percentages of the oxides for each of the Examples 1-3 are set forth in Table 1 below. The last row is a calculated ratio of CuO to Fe₂O₃.

TABLE 1

| | Example 1 | Example 2 | Example 3 |
|---|---|---|---|
| Oxide | (mole %) | (mole %) | (mole %) |
| SiO₂ | 45 | 40 | 40 |
| P₂O₅ | 5 | 5 | 5 |
| B₂O₃ | 9 | 9 | 6.5 |
| K₂O | 9 | 9 | 6.5 |
| Fe₂O₃ | 10 | 10 | 15 |
| CuO | 20 | 25 | 25 |
| Al₂O₃ | 2 | 2 | 2 |
| CuO/Fe₂O₃ | 2.0 | 2.5 | 1.7 |

The composition of each of the substrates of Examples 1-3 were then measured using X-ray fluorescence spectrometry, with all Cu-containing components considered to be CuO and all Fe-containing components considered to be Fe₂O₃. The measured mole percentages for each oxide for each of Examples 1-3 are set forth in Table 2 below. Again, the last row is a calculated ratio of CuO to Fe₂O₃.

TABLE 2

| | Example 1 | Example 2 | Example 3 |
|---|---|---|---|
| Oxide | (mole %) | (mole %) | (mole %) |
| SiO₂ | 49.1 | 54.5 | 55.7 |
| P₂O₅ | 4.6 | 4.2 | 3.9 |
| B₂O₃ | 8.9 | 5.9 | 4.1 |
| K₂O | 6.9 | 6.2 | 4.6 |
| Fe₂O₃ | 9.5 | 8.3 | 12.0 |
| CuO | 19.1 | 19.2 | 17.9 |
| Al₂O₃ | 1.9 | 1.7 | 17.9 |
| CuO/Fe₂O₃ | 2.0 | 2.3 | 1.5 |

As discussed above, the measured mole percentages for the oxides are different than the mole percentages of the oxides as batched to form the substrates, likely because of the different oxides becoming volatile in different proportions during heating of the oxides to form the melt.

The substrates were then ground into a powder (e.g., a plurality of particles of the substrate). Powder from each of the Examples 1-3 were analyzed via X-ray diffraction to identify particular crystalline formations that had formed in the substrate using such commercially available equipment as the model PW1830 (Cu Kα radiation) diffractometer manufactured by Philips, Netherlands. In addition, each of the substrates of Examples 1-3 were fractured and a SEM EDS analysis was performed to depict and identify the different components of the substrate.

The X-ray diffraction analysis for Example 1 is graphically reproduced at FIG. 8. The analysis revealed the presence of cuprite (CuO), magnetite (Fe₃O₄), and delafossite (CuFeO₃). In addition, the analysis revealed the presence of crystals of potassium aluminosilicate, K(AlSi₃O₈). As discussed, cuprite is the antimicrobial component of the substrate of Example 1. Magnetite, and to a lesser extent delafossite, are the magnetizable components of the substrate of Example 1. Potassium aluminosilicate is neither antimicrobial nor magnetizable.

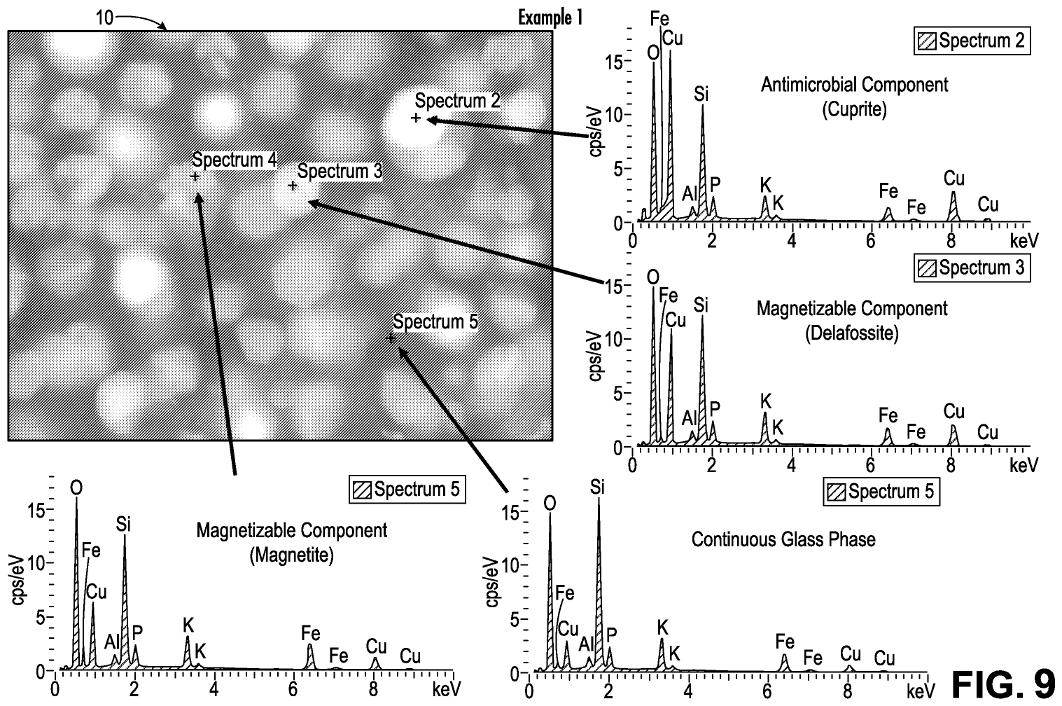

The SEM image and EDS analysis of the unpolished substrate of Example 1 are reproduced at FIG. 9. The brightest areas of the SEM image (“Spectrum 2”) are relatively rich in copper and presumed to be the cuprite identified through x-ray diffraction. A darker area of the SEM image (“Spectrum 3”) was relatively rich in copper and also included iron (Fe) and is presumed to be a crystal of delafossite. Another crystal illustrated in the SEM image (“Spectrum 4”) included the lowest amount of copper amongst the crystals and the highest amount of iron and is presumed to be magnetite. The dark sea around the crystals in the SEM image (“Spectrum 5”) included predominately silicon and is the continuous glass phase. The circular shading around the cuprite (“Spectrum 2”) is an example of the discontinuous glass phase.

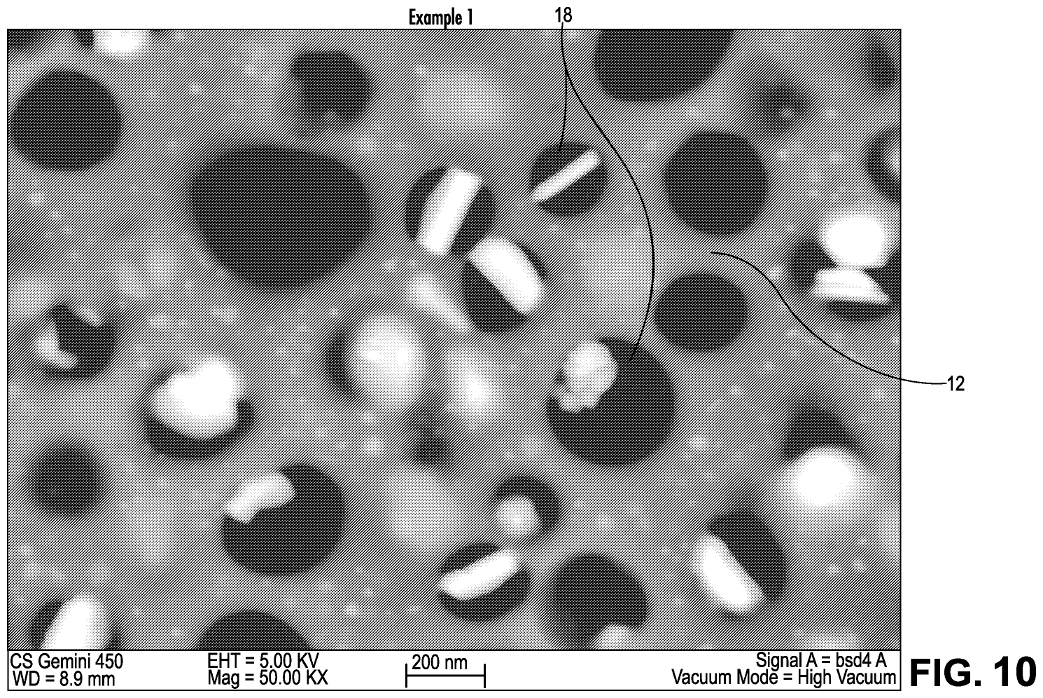

The SEM image of the polished substrate of Example 1 is reproduced at FIG. 10. The substrate was polished with water. As discussed above, the discontinuous glass phase is more soluble in water than the continuous glass phase. Accordingly, polishing removes a portion of the discontinuous glass phase to expose crystals of the magnetizable component and the antimicrobial component at the surface. The image of the polished substrate readily distinguishes between the discontinuous glass phase, as generally round islands within the sea of the continuous glass phase. Also note that the crystals of the magnetizable component or the antimicrobial component have a maximum dimension of about 200 nm, or 100 nm to 300 nm.

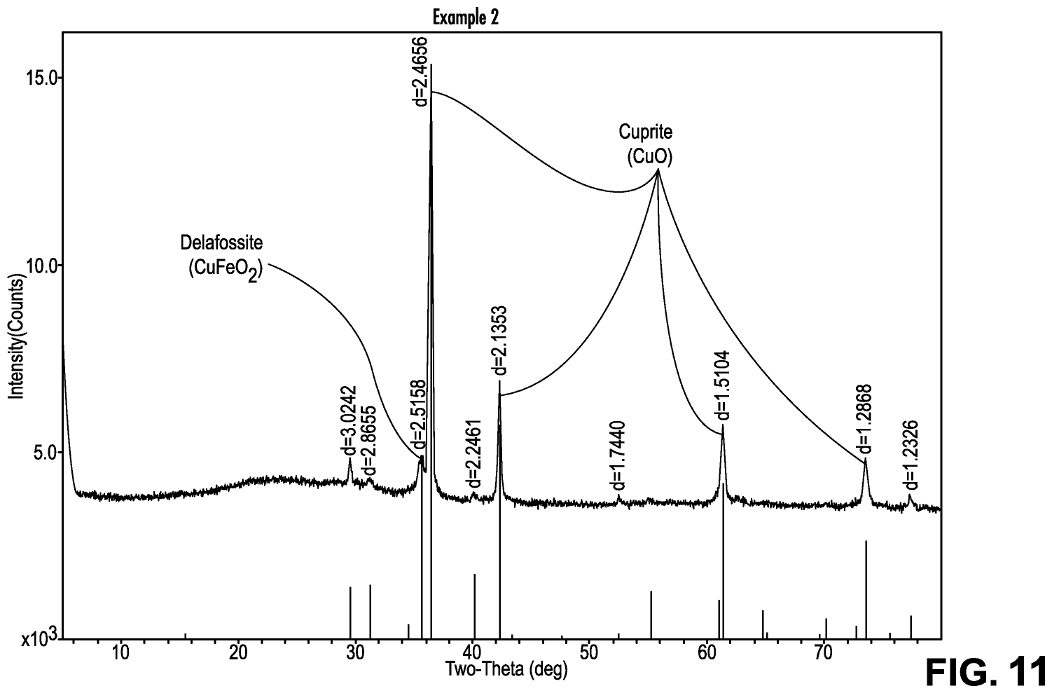

The X-ray diffraction analysis for Example 2 is graphically reproduced at FIG. 11. The analysis revealed the presence of cuprite (CuO) and delafossite (CuFeO₃), but not magnetite (Fe₃O₄). As discussed, cuprite is the antimicrobial component of the substrate of Example 2. Delafossite is the magnetizable components of the substrate of Example 2. Upon comparing Example 1 to Example 2, it appears that raising the ratio of CuO to Fe₂O₃ to form the respective substrates from 2 (or 1.9 to 2.1) to 2.5 (or 2.4 to 2.6) suppresses the generation of magnetite and causes the generation of delafossite exclusively as the magnetizable component. Either ratio allowed for the generation of cuprite as the antimicrobial component.

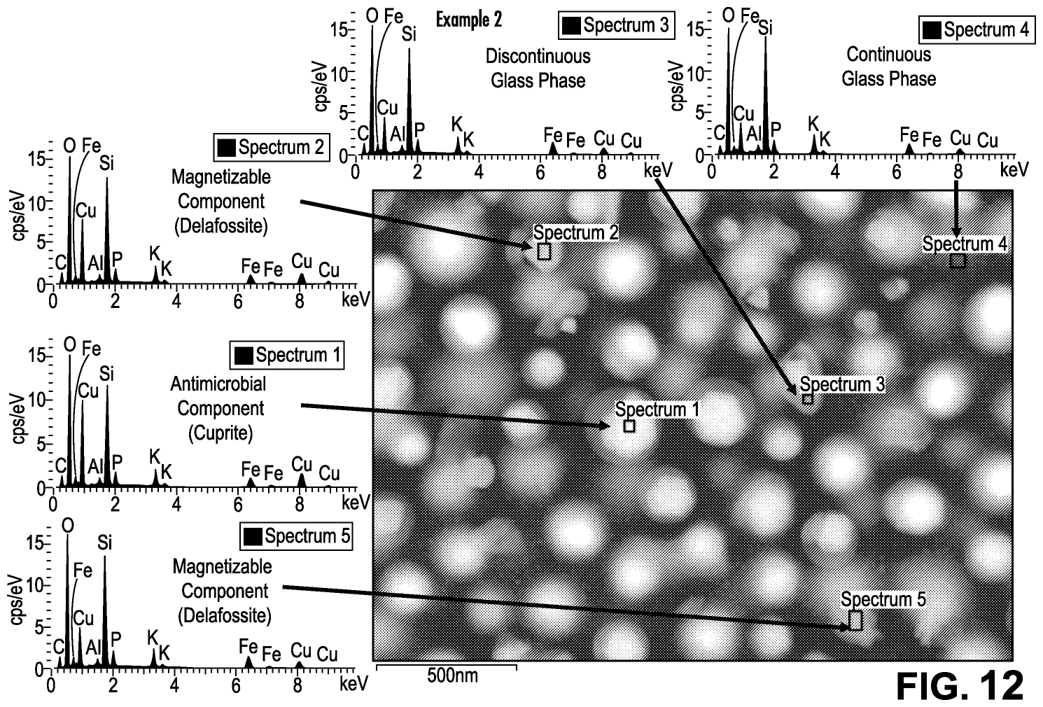

The SEM image and EDS analysis of the substrate of Example 2, after polishing, are reproduced at FIG. 12. The crystal labeled as “Spectrum 1” have a relatively high amount of copper and is presumed to be cuprite. The crystals labeled as “Spectrum 2” and “Spectrum 5” include less copper and more iron are presumed to be delafossite. The islands surrounding the crystals (“Spectrum 3”) contain a relatively high amount of phosphorous and are each the discontinuous glass phase. The darker sea (“Spectrum 4”) surrounding the islands of the discontinuous glass phase is the continuous glass phase.

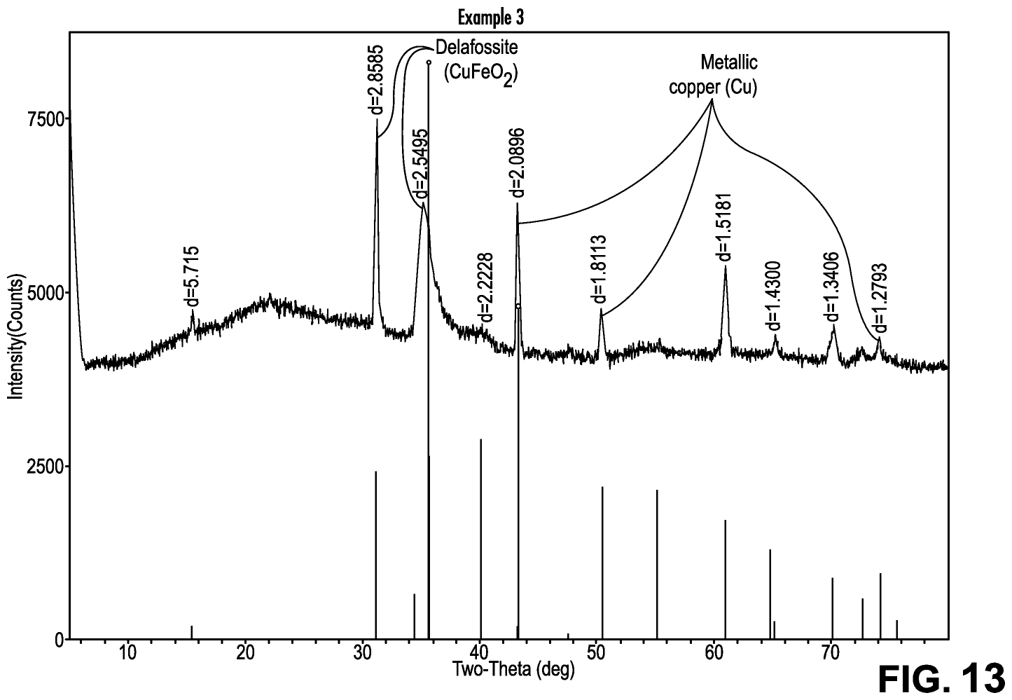

The X-ray diffraction analysis for Example 3 is graphically reproduced at FIG. 13. The analysis revealed the presence of metallic copper (Cu) and delafossite (CuFeO₃) but not magnetite (Fe₃O₄). As discussed, metallic copper is the antimicrobial component of the substrate of Example 3. Delafossite is the magnetizable components of the substrate of Example 2. Upon comparing Example 1 to Example 3, it appears that lowering the ratio of CuO to Fe₂O₃ to form the respective substrates from 2 (or 1.9 to 2.1) to 1.6 (or 1.5 to 1.7) suppresses the generation of magnetite and cause the generation of delafossite exclusively as the magnetizable component. The lower ratio of 1.6 resulted in the formation of metallic copper instead of cuprite. It is believed that the elevated temperatures utilized to form the substrate exhausted oxygen necessary to form cuprite (CuO) instead of copper. In any event, metallic copper exhibits antimicrobial activity.

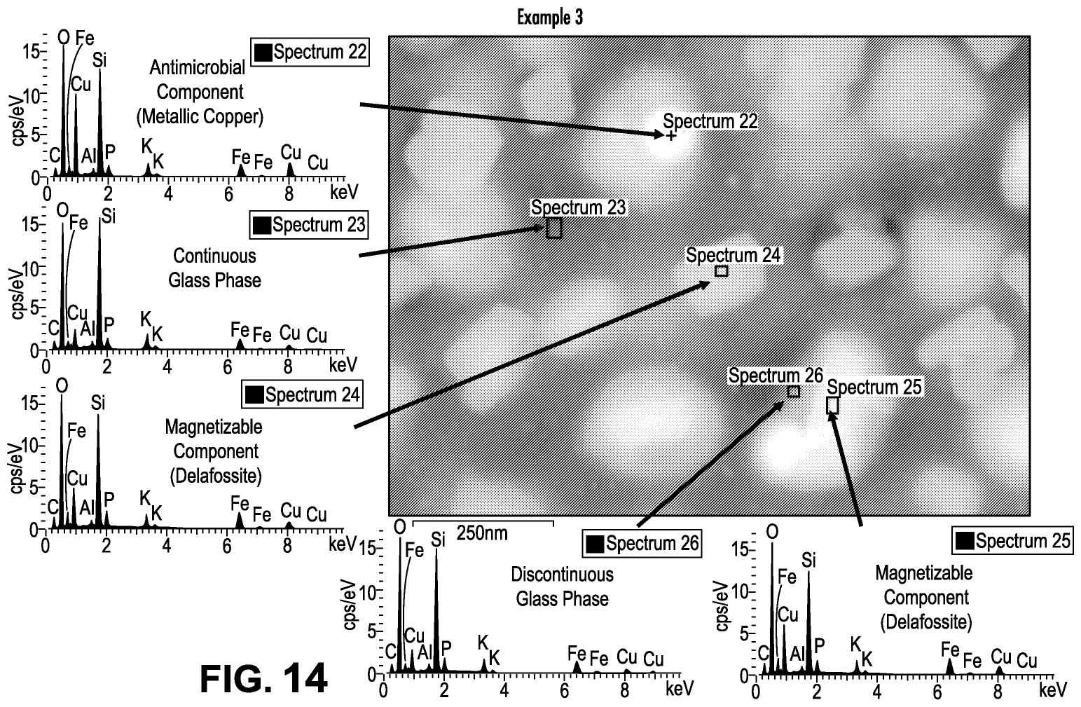

The SEM images and EDS analysis of the substrate of Example 3 are reproduced at FIG. 14. The crystal identified as “Spectrum 22” is metallic copper. The dark sea identified as “Spectrum 23” is the continuous glass phase and has a relatively high amount of silicon. The crystals identified as “Spectrum 24” and “Spectrum 25” are delafossite, being relatively high in iron and containing copper. “Spectrum 26” surrounding crystals of delafossite has a relatively high amount of phosphorous and is the discontinuous glass phase.

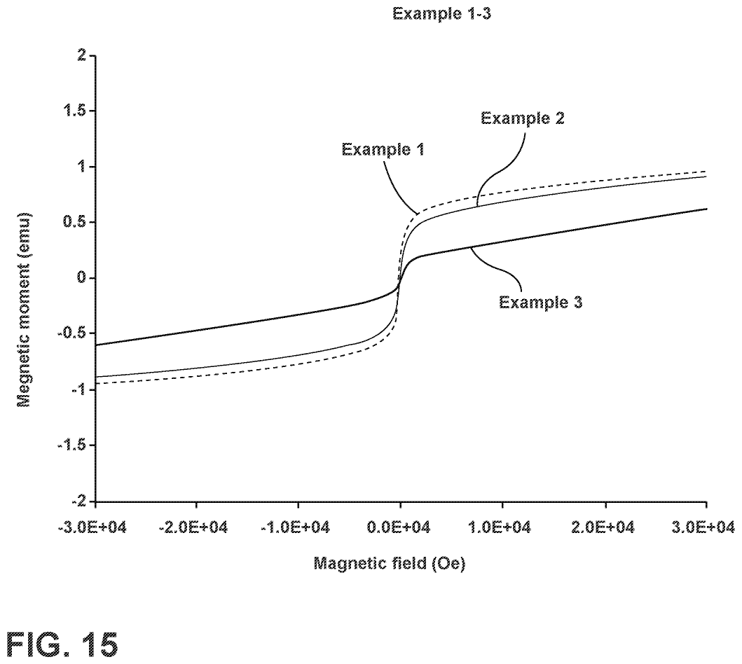

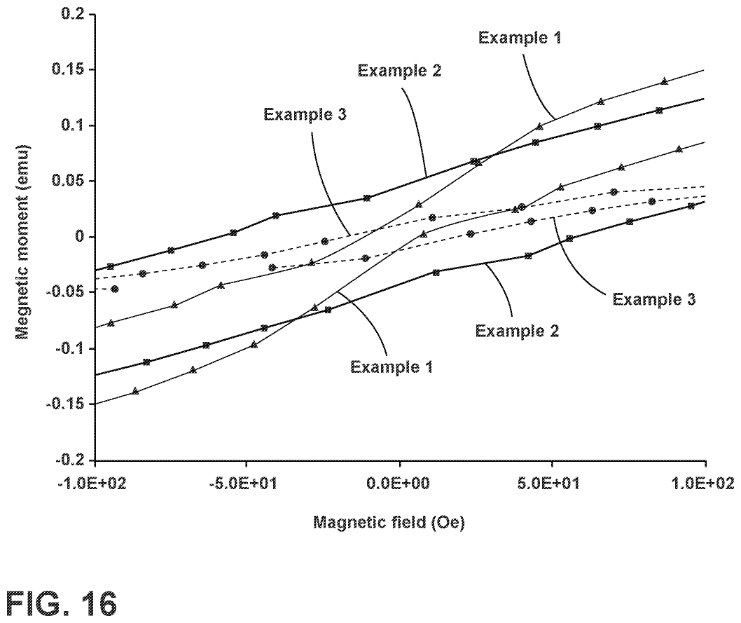

Referring now to FIGS. 15 and 16, the magnetic moment as a function of magnetic field for each of the substrates of Examples 1-3 were measured. Magnetic moments were measured with the vibrating sample magnetometer function of the Quantum Design Physical Property Measurement System distributed by Quantum Design North America. For the measurements, a sample of each of the substrates of Examples 1-3 were prepared to have a cylindrical shape of a length of 10 mm and a diameter of 4.5 mm. Each sample had a mass of about 0.5 grams. As the graphs illustrate, Example 1 exhibited the greatest overall response to the magnetic fields applied, followed by Example 2 and then Example 3. FIG. 16 has two distinct data lines for each Example due to hysteresis that is typical of magnetizable materials.

The differences in magnetization allow for several conclusions to be drawn. First, the ratio of the mole percentage of CuO to the mole percentage of Fe₂O₃ is more strongly correlated with the magnetization of the substrate than the mole percentage of Fe₂O₃ alone. The substrate of Example 3 as batched included the greatest mole percentage of iron in the form of Fe₂O₃. However, the substrate of Example 3 exhibited the least magnetization of the three examples. However, the substrate of Example 3 did include the smallest ratio of CuO to Fe₂O₃ as batched (1.7) and as formed (1.5). For Example 1 and Exhibit 2, the ratios as batched were 2.0 and 2.5, respectively, and as formed were 2.0 and 2.3, respectively. Accordingly, to optimize the magnetization of the substrate, the ratio both as batched and as formed ought to be greater than 1.9.

Second, the type of iron-containing crystal formed during formation of the substrate is more strongly correlated with the magnetization of the substrate than the ratio of CuO to Fe₂O₃ as batched and as formed. Example 1 exhibited slightly greater magnetization than Example 2. However, as mentioned, the ratios as batched were 2.0 and 2.5, respectively, and as formed were 2.0 and 2.3, respectively for Example 1 and Example 2. If magnetization were a function of the ratio of CuO to Fe₂O₃ alone, then Example 2, having the greatest ratio, would have exhibited the greatest magnetization. However, Example 1 did. Without being bound by theory, it is believed that Example 1 exhibited greater magnetization than Example 2 because the Fe₂O₃ as batched in Example 1 generated crystals of magnetite, while the Fe₂O₃ as batched in Example 2 generated crystals of delafossite, which is less magnetizable than magnetite. Thus, to generate crystals of magnetite instead of delafossite, to optimize the magnetization of the substrate, the ratio of CuO to Fe₂O₃ ought to be 1.8 to 2.2, or 1.9 to 2.1 (both as batched and in the substrate as formed).

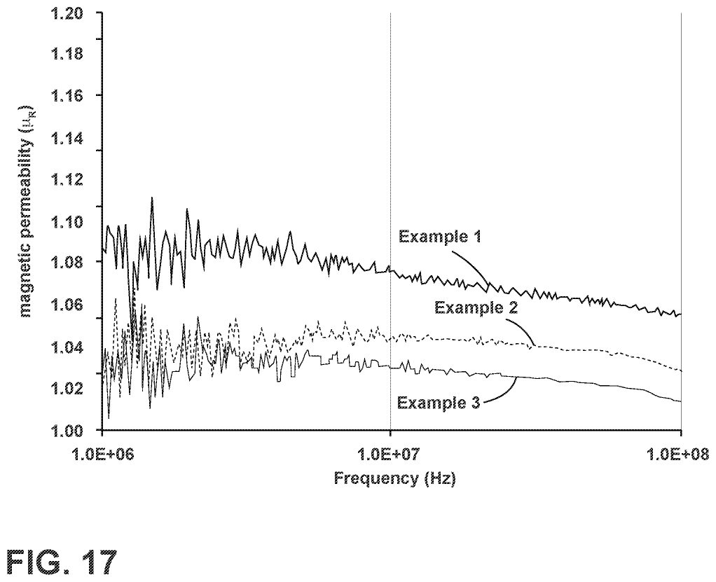

Referring now to FIG. 17, the magnetic permeability of the substrates of Examples 1-3 were measured. A graph of the results is reproduced there. The Impedance/material Analyzer 4291 B from Agilent Technologies was utilized to make the measurements. For the measurement, a sample of each of the substrates from Examples 1-3 were prepared into an annular or a donut shape having a thickness of 5 mm, an inner diameter of 7.5 mm, and an outer diameter of 13 mm. As the graph illustrates, Example 1 exhibited the greatest magnetic permeability, followed by Example 2 and then Example 3. These results are consistent with the results for the magnetic moment as a function of magnetic field described above. Magnetite, present only in Example 1, provides greater magnetic permeability than delafossite present in Examples 2 and 3. Although the mole percentage of Fe₂O₃ in Example 3 exceeded that of Example 2, Example 2 exhibited greater magnetic permeability because the ratio of CuO to Fe₂O₃ in Example 2 was greater than in Example 3.

In addition to magnetism related properties, the antimicrobial efficacy of the substrates of Examples 1-3 were measured. The substrate for each of Examples 1-3 were ground into a plurality of particles of the substrate (i.e., a powder) and added to liquid paint in varying concentrations from 6 grams per gallon to 50 grams per gallon. The powder had a D50 particle size of 2.8 μm to 3.6 μm. The liquid paint was commercially available Behr Premium Plus Interior (Ultra Pure White) Eggshell finish. The powder was in the paint for two days before the antimicrobial efficacy was tested.

Paint containing the powder was then applied as a film onto a Lenata scrub test panel. The film dried over a period of two days in an environment having ambient temperature. The thickness of the film after drying was about 80 μm. One inch by one inch square coupons were then cut from the center of the scrub test panel.

The antimicrobial efficacy was then determined against Staphylococcus Aureus pursuant to the procedures outlined in the United States Environmental Protection Agency Office of Pesticide Programs Protocol for the Evaluation of Bactericidal Activity of Hard, Non-porous Copper Containing Surface Products, dated 29 Jan. 2016.

The results are set forth in Table 3 below. The third to last row is the measured mole percentage of CuO in the substrate of the Example, assuming all copper is CuO. The penultimate row is the calculated ratio of CuO to Fe₂O₃ in the substrate as formed. The final row is the type of copper-containing crystal in the substrate of the particular example.

TABLE 3

| Concentration of | Example 1 - | Example 2 - | Example 3 - |
|---|---|---|---|
| powder in paint | Log₁₀ | Log₁₀ | Log₁₀ |
| (g/gal) | reduction | reduction | reduction |
| 6 | 1.97 | 5.78 | 1.97 |
| 10 | 2.2 | 5.78 | 2.7 |
| 15 | 2.48 | 5.78 | 2.76 |
| 25 | 4.38 | 5.78 | 5.78 |
| 50 | 5.54 | 5.78 | 5.78 |
| CuO | 19.1 | 19.2 | 17.9 |
| CuO/Fe₂O₃ | 2.0 | 2.3 | 1.5 |
| Cu-containing crystal | Cuprite | Cuprite | Metallic Cu |

Several conclusions are drawn from the results. First, at even the lowest concentration, both cuprite and metallic copper exhibit greater than 1 log₁₀ antimicrobial efficacy. Second, when sufficiently concentrated, both cuprite and metallic copper exhibited greater than 3 log₁₀ antimicrobial efficacy.

Third, when the copper is in the form of cuprite, the higher the ratio of CuO/Fe₂O₃ in the substrate as formed, the greater the log₁₀ reduction for any given concentration of the substrate in the paint. However, as explained above, this increase in antimicrobial activity comes at the expense of decreased magnetic moment and magnetic permeability.

Comparative Examples 4 and 5. For Comparative Examples 4 and 5, a plurality of oxides were batched similar to those of Example 1-3 but including less CuO, and a substrate was formed. The composition of both of the substrates of Comparative Examples 4 and 5 were then measured using X-ray fluorescence spectrometry, with all Cu-containing components considered to be CuO and all Fe-containing components considered to be Fe₂O₃. The measured mole percentages for each oxide for each of Comparative Examples 4 and 5 are set forth in Table 4 below. Again, the last row is a calculated ratio of CuO to Fe₂O₃.

TABLE 4

| | Comparative | Comparative |
|---|---|---|
| | Example 1 | Example 2 |
| Oxide | (mole %) | (mole %) |
| SiO₂ | 60.0 | 58.3 |
| P₂O₅ | 3.4 | 3.5 |
| B₂O₃ | 5.4 | 3.6 |
| K₂O | 6.0 | 4.5 |
| Fe₂O₃ | 10.8 | 15 |
| CuO | 13.0 | 13.6 |
| Al₂O₃ | 1.4 | 1.5 |
| CuO/Fe₂O₃ | 1.20 | 0.91 |

X-ray diffraction analysis were performed on the substrates of Comparative Examples 4 and 5. The analysis identified crystals of delafossite and metallic copper in the substrate of Comparative Example 4. The analysis identified crystals of delafossite and magnetite in the substrate of Comparative Example 5.

Both the substrates of Comparative Examples 4 and 5 were ground into a powder. The powder was mixed into paint. The paint was tested for antimicrobial activity, in the manner discussed above for Examples 1-3. However, unlike Examples 1-3, Comparative Examples 4 and 5 did not exhibit antimicrobial activity.

Several conclusions can be drawn. First, Comparative Example 2 did not exhibit antimicrobial activity because formation of the substrate did not generate crystals of cuprite or metallic copper. Rather, only delafossite and magnetite formed. Cuprite and metallic copper exhibit much more antimicrobial activity than delafossite. Delafossite but neither cuprite nor metallic copper formed presumably because the ratio of CuO to Fe₂O₃ was less than 1.0, at 0.91. Further, at a mole percentage CuO of 13.6, the quantity of delafossite in the substrate was insufficient for the substrate to exhibit measureable antimicrobial activity. However, it should be noted that a mole percentage of CuO of at least 20 mole percentage would likely generate sufficient delafossite to exhibit measurable antimicrobial activity.

Second, Comparative Example 1 did not exhibit antimicrobial activity because formation of the substrate did not form cuprite at all and did not generate sufficient metallic copper to provide appreciable antimicrobial activity. No cuprite and insufficient metallic copper was formed presumably because the ratio of CuO to Fe₂O₃ was less than 1.3, at 1.20. Note that Example 3, which generated just metallic copper, produced sufficient metallic copper to provide appreciate antimicrobial activity at a ratio of CuO to Fe₂O₃ of greater than 1.3, at 1.50.

It will be apparent to those skilled in the art that various modifications and variations can be made without departing from the spirit or scope of the claims.

1. A substrate comprising:
a continuous glass phase;
a magnetizable component; and
an antimicrobial component.

2. The substrate of claim 1 further comprising:
a discontinuous glass phase disposed in the continuous glass phase;
wherein, the magnetizable component and the antimicrobial component are disposed in the discontinuous glass phase.

3. The substrate of claim 2, wherein
a mole percentage of SiO₂ in the continuous glass phase is greater than a mole percentage of SiO₂ in the discontinuous glass phase;
a mole percentage of P₂O₅ the discontinuous glass phase is greater than a mole percentage of P₂O₅ in the continuous glass phase;
one or more of delafossite and magnetite is disposed in the discontinuous glass phase; and
one or more of cuprite and metallic copper is disposed in the discontinuous glass phase.

4. The substrate of claim 1 further comprising:
a composition comprising SiO₂, B₂O₃, P₂O₅, and K₂O.

5. The substrate of claim 4, wherein
the composition comprises (in mole percentage):
45 percent to 60 percent SiO₂;
3 percent to 6 percent P₂O₅;
3 percent to 10 percent B₂O₃;
4 percent to 8 percent K₂O;
7 percent to 15 percent Fe₂O₃; and
15 percent to 25 percent CuO;
wherein, a sum of the mole percentages of the composition is 100 percent, the mole percentages are determined on an oxide basis, and the mole percentages are determined via X-ray fluorescence spectrometry with all Cu-containing components considered to be CuO and all Fe-containing components considered to be Fe₂O₃.

6. The substrate of claim 5, wherein
a ratio of the mole percentage of CuO in the composition to the mole percentage of Fe₂O₃ in the composition is 1.3 to 3.0.

7. The substrate of claim 1, wherein
the magnetizable component comprises one or more of delafossite and magnetite.

8. The substrate of claim 1, wherein
the antimicrobial component comprises one or more of cuprite and metallic copper.

9. (canceled)

10. The substrate of claim 1, wherein
the substrate exhibits a magnetic permeability of greater than or equal to 1.02μ_{R} at a frequency of 10,000,000 Hz.

11. The substrate of claim 1, wherein
the substrate exhibits greater than 3 log₁₀ reduction of Staphylococcus Aureus.

12. A method of forming the substrate of claim 1, the method comprising:
melting a plurality of oxides together to form a melt; and
cooling the melt to form the substrate, wherein the continuous glass phase is from the plurality of oxides, the magnetizable component is from the plurality of oxides, and the antimicrobial component is from the plurality of oxides.

13. The method of claim 12 further comprising:
subjecting the substrate to an environment having a temperature of at least 500° C. for at least 30 minutes.

14. (canceled)

15. The method of claim 12 further comprising:
transforming the substrate into a plurality of particles of the substrate.

16. The method of claim 12, wherein
the plurality of oxides melted together comprise SiO₂, P₂O₅, B₂O₃, and K₂O.

17. The method of claim 16, wherein
the plurality of oxides melted together further comprise iron oxide and another metallic oxide from which the antimicrobial component is formed.

18. The method of claim 17, wherein
the iron oxide comprises Fe₂O₃, and the metallic oxide comprises CuO.

19. The method of claim 16, wherein the plurality of oxides melted together comprise (as batched, on an oxide basis, in mole percentage, with the total mole percentage of the plurality of oxides being 100 percent):
35 percent to 50 percent SiO₂;
3 percent to 8 percent P₂O₅;
5 percent to 12 percent B₂O₃;
5 percent to 11 percent K₂O;
7 percent to 17 percent Fe₂O₃; and
15 percent to 30 percent CuO.

20.-22. (canceled)

23. A method of sanitizing a liquid comprising:
placing a plurality of particles in a liquid, each of the plurality of particles comprising:
a continuous glass phase, a magnetizable component, and an antimicrobial component; and
removing the plurality of particles from the liquid.

24.-27. (canceled)

28. An article comprising:
a surface;
a plastic section forming part of the surface; and
a plurality of particles held in place by the plastic section, the plurality of particles positioned so that a portion of the plurality of particles also form part of the surface of the article, and each of the plurality of particles comprising a continuous glass phase, a magnetizable component, and an antimicrobial component.

29.-32. (canceled)

33. A method of forming the article of claim 28, the method comprising:
molding plastic and the plurality of particles together to form the article while the plurality of particles is subjected to a magnetic field.

34.-35. (canceled)
